(19) United States
(12) Patent Application Publication
(10) Pub. No.: US 2013/0108806 A1
(43) Pub. Date: May 2, 2013

(54) WINDOW FOR DISPLAY PROTECTION AND DISPLAY USING THE SAME

(71) Applicants: Sang-Woo Han, Yongin-City (KR); Dong-Ho Lee, Yongin-City (KR); Ju-Suk Oh, Yongin-City (KR); Hak-Sun Kim, Yongin-City (KR); Kwan-Young Han, Yongin-City (KR); Kyu-Taek Lee, Yongin-City (KR); Sang-Gu Kim, Yongin-City (KR)

(72) Inventors: Sang-Woo Han, Yongin-City (KR); Dong-Ho Lee, Yongin-City (KR); Ju-Suk Oh, Yongin-City (KR); Hak-Sun Kim, Yongin-City (KR); Kwan-Young Han, Yongin-City (KR); Kyu-Taek Lee, Yongin-City (KR); Sang-Gu Kim, Yongin-City (KR)

(73) Assignee: SAMSUNG DISPLAY CO., LTD., Yongin-City (KR)

(21) Appl. No.: 13/604,117

(22) Filed: Sep. 5, 2012

(30) Foreign Application Priority Data
Oct. 28, 2011 (KR) 10-2011-0111314

(51) Int. Cl. B32B 7/02; B32B 27/32; B32B 7/12; B32B 9/04

(52) U.S. Cl. 428/1.1; 428/447; 428/523; 428/215

(57) ABSTRACT

A display protection window and a display device having the same. The display protection window includes a first plastic film, a second plastic film arranged opposite to the first plastic film, and an adhesive layer disposed between the first plastic film and the second plastic film to bond the first plastic film and the second plastic film to each other.

### CLAIM OF PRIORITY

This application makes reference to, incorporates the same herein, and claims all benefits accruing under 35 U.S.C. §119 from an application earlier filed in the Korean Intellectual Property Office on Oct. 28, 2011 and there duly assigned Serial No. 10-2011-0111314.

### BACKGROUND OF THE INVENTION

1. Field of the Invention

An exemplary embodiment of the present invention relates generally to a display protection window and a display device having the same. More particularly, it relates to a display protection window that can effectively suppress bending deformation while having improved impact resistivity with a relatively slim thickness, and a display device having the same.

2. Description of the Related Art

Recently, a flat panel display that can be carried by a user has been in the spotlight as a typical display device. An easy portable flat panel display includes an organic light emitting diode (OLEO) display, a liquid crystal display (LCD), an electrophoretic display, etc.

The above information disclosed in this Background section is only for enhancement of understanding of the background of the described technology and therefore it may contain information that does not form the prior art that is already known in this country to a person of ordinary skill in the art,

### SUMMARY OF THE INVENTION

The described technology has been made in an effort to provide an improved display protection window.

In addition, the present invention provides a display protection window that can improve impact resistance and effectively suppress a warpage while having a relatively slim thickness.

Further, the present invention provides a display device that can he safely protected by having the display protection window.

According to one aspect of the present invention, a display protection window is constructed with a first plastic film, a second plastic film arranged opposite to the first plastic film, and an adhesive layer disposed between the first plastic film and the second plastic film to bond the first plastic film and the second plastic film to each other.

The adhesive layer may be at least one of an optical clear adhesive (OCA) layer and a super view resin (SVR).

The first plastic film and the second plastic film may respectively include at least one of polymethyl methacrylate (PMMA) and polysilsesquioxane.

The first plastic film and the second plastic film may respectively have a thickness included in a range of approximately 0.25 mm to 0.35 mm, and the adhesive layer may have a thickness included in a range of approximately 0.05 mm to 0.15 mm.

The display protection window may further include a third plastic film disposed between the first plastic film and the adhesive layer and a fourth plastic film disposed between the second plastic film and the adhesive layer.

The sum of the thickness of the first plastic film and the thickness of the third plastic film may be included in a range of approximately 0.25 mm to 0.35 mm, the sum of the thickness of the second plastic film and the thickness of the fourth plastic film may be included in a range of approximately 0.25 mm to 0.35 mm, and the adhesive layer may have a thickness included in a range of approximately 0.05 mm to 0.15 mm.

The first plastic film and the second plastic film may be formed of the same material, and the third plastic film and the fourth plastic film may be formed of the same material.

The first plastic film and the fourth plastic film may be formed of the same material, and the second plastic film and the third plastic film may be formed of the same material.

In addition, the adhesive layer may include a first adhesive layer adjacent to the first plastic film and a second adhesive layer adjacent to the second plastic film, and may further include an additional plastic film disposed between the first adhesive layer and the second adhesive layer.

The first adhesive layer and the second adhesive layer may respectively have a thickness included in a range of approximately 0.01 mm to 0.1 mm, and the additional plastic film may have a thickness included in a range of approximately 0.15 mm to 0.3 mm.

The first plastic film and the second plastic film may respectively have a thickness included in a range of approximately 0.25 mm to 0.35 mm.

The display protection window may further include a third plastic film disposed between the first plastic film and the first adhesive layer and a fourth plastic film disposed between the second plastic film and the second adhesive layer.

The sum of the thickness of the first plastic film and the thickness of the third plastic film may be included in a range of approximately 0.25 mm to 0.35 mm, the sum of the thickness of the second plastic film and the thickness of the fourth plastic film may be included in a range of approximately 0.25 mm to 0.35 mm, and the adhesive layer may have a thickness included in a range of approximately 0.05 mm to 0.15 mm.

The first plastic film and the second plastic film may be formed of the same material, and the third plastic film and the fourth plastic film may be formed of the same material.

The first plastic film and the fourth plastic film may be formed of the same material, and the second plastic and the third plastic film may be formed of the same material.

According to another aspect of the present invention, a display device is constructed with a display panel displaying an image and the display protection window disposed on the display panel to protect the display panel.

The display panel may be one of an organic light emitting diode display panel, a liquid crystal display panel, and an electrophoretic display panel.

According to the exemplary embodiments, the display protection window can have improved impact resistance and can effective suppress a warpage while having a relatively slim thickness.

Further, the display device can be safely protected by having the display protection window.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view of a display protection window constructed as a first exemplary embodiment according to the principles of the present invention;

FIG. 2 is a cross-sectional view of a display device including a display protection window constructed as an exemplary embodiment according to the principles of the present invention;

FIG. 3 is a cross-sectional view of a display protection window constructed as a second exemplary embodiment according to the principles of the present invention;

FIG. 4 is a cross-sectional view of a display protection window constructed as a third exemplary embodiment according to the principles of the present invention;

FIG. 5 is a cross-sectional view of a display protection window constructed as a fourth exemplary embodiment according to the principles of the present invention;

FIG. 6 is a cross-sectional view of a display protection window constructed as a Comparative example 1;

FIG. 7 is a cross-sectional view of a display protection window constructed as a Comparative example 2; and

FIG. 8 is a cross-sectional view of a display protection window constructed as a Comparative example 3.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In various exemplary embodiments, the same reference numerals are used for the elements having the same configuration and will be representatively described in a first exemplary embodiment, and in other exemplary embodiments, only elements different from those of the first exemplary embodiment will be described.

The drawings are schematic and not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. It will be understood that when an element is referred to as being “on” another element, it can be directly on another element or intervening elements may be present therebetween.

Exemplary embodiments represent ideal exemplary embodiments in detail. As a result, modifications of diagrams are expected. Accordingly, exemplary embodiments are not limited to specific shapes of shown regions, and for example, also include modifications of the shape by manufacturing.

A display device is provided with a display protection window disposed on a display panel. The display protection window protects the display panel from external impact or a scratch. In order to reduce the entire thickness of the display device and simplify an assembling process, the display protection window and the display panel are manufactured in the bonded state.

When the display protection window is manufactured by using generally-used plastic having a single component, however, an impact resistance characteristic of the display protection window may be deteriorated due to weakness of the plastic itself. Further, when the display protection window is manufactured by bonding different types of plastic films to improve impact resistance, a warpage occurs due to differences of characteristics such as an absorption rate and an expansion rate between the two materials, thereby causing dimension instability.

The above information disclosed in this Background section is only for enhancement of understanding of the background of the described technology and therefore it may contain information that does not form the prior art that is already known in this country to a person of ordinary skill in the art.

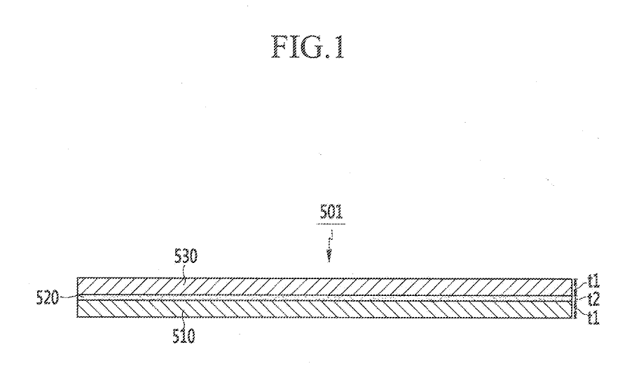

Hereinafter, a display protection window 501 constructed as a first exemplary embodiment according to the principles of the present invention will be described with reference to FIG. 1.

As shown in FIG. 1, a display protection window 501 constructed as the first exemplary embodiment includes a first plastic film 510, a second plastic film 530, and an adhesive layer 520.

The first plastic film 510 and the second plastic film 530 are arranged opposite to each other. The adhesive layer 520 is disposed between the first plastic film 510 and the second plastic film 530 to bond the first plastic film 510 and the second plastic film 530 to each other.

The first plastic film 510 and the second plastic film 530 respectively include at least one of polymethyl methacrylate (PMMA) and polysilsesquioxane. In this case, the first plastic film 510 and the second plastic film 530 may be formed of the same material or may be formed of different materials.

The adhesive layer 520 may be at least one of an optical clear adhesive (OCA) layer and a super view resin (SVR).

In the first exemplary embodiment, the first plastic film 510 and the second plastic film 530 respectively have thicknesses t1 of approximately 0.25 mm to 0.35 mm. In addition, the adhesive layer 520 has a thickness t2 of approximately 0.05 mm to 0.15 mm.

With such a configuration, the display protection window 501 constructed as the first exemplary embodiment has a relatively slim thickness and improved impact resistance and can effectively suppress warpage thereof.

That is, the display protection window 501 constructed as the first exemplary embodiment has an improved impact resistance while having a thickness of less than 0.7 mm and can have excellent a suppression force with respect to warpage.

In further detail, the adhesive layer 520 formed of a relatively soft material is disposed between the first and second plastic films 510 and 530 to absorb impact therebetween and release stress generated therebetween. In addition, in the first exemplary embodiment, an optical clear adhesive (OCA) layer and a super view resin (SVR) used as the adhesive layer 520 has excellent thermal characteristic such that warpage of the display protection window 501 can be effectively suppressed.

Further, when the first plastic film 510 and the second plastic film 530 are formed of different materials, deformation of the first and second plastic films 510 and 530 due to a difference of thermal expansion coefficients therebetween can be effectively corrected. That is, the difference of thermal expansion coefficient between one of the first plastic film 510 and the second plastic film 530, and the adhesive layer 520 is relatively smaller than the difference of thermal expansion coefficient between another the first plastic film 510 and the second plastic film 530, and the adhesive layer 520. Accordingly, the deformation of the first and second plastic films 510 and 530 can be offset by the difference of thermal expansion coefficients,

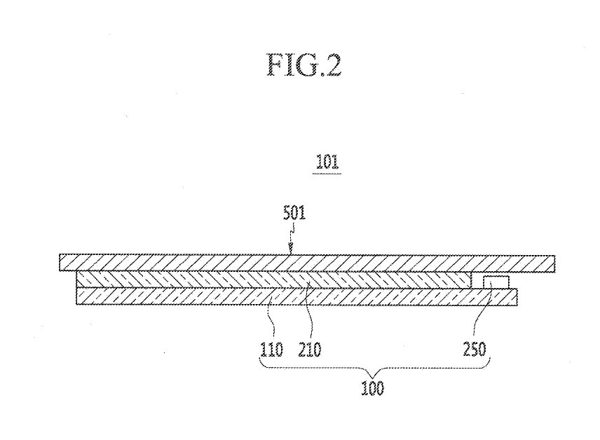

Hereinafter, a display device 101 having the display protection window 510 constructed as the first exemplary embodiment will be described with reference to FIG. 2.

The display device 101 includes a display panel 100 displaying an image and the display protection window 501 of FIG. 1.

The display panel 100 may include a display substrate 110 where a display element is formed, an encapsulation substrate 210 protecting the display element, and a driving circuit element 250.

In the first exemplary embodiment, according to the type of the display element of the display panel 100, the display panel 100 may be one of an organic light emitting diode display panel, a liquid crystal display panel, and an electrophoretic display panel,

With such a configuration, the display device 101 can be safely protected by the display protection window 510 of FIG. 1.

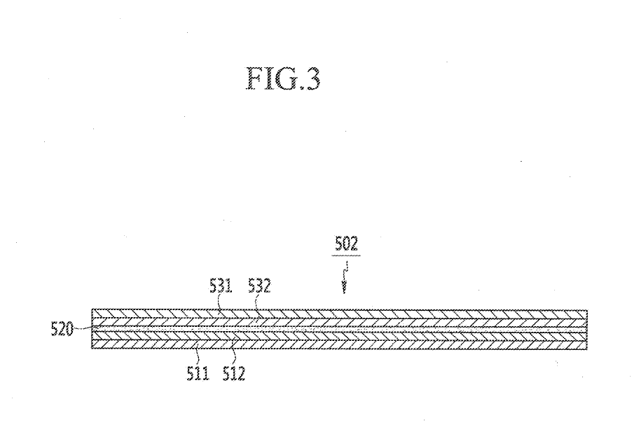

Hereinafter, a display protection window 502 constructed as a second exemplary embodiment according to the principles of the present invention will be described with reference to FIG. 3.

As shown in FIG. 3, the display protection window 502 constructed as the second exemplary embodiment further includes a third plastic film 512 disposed between a first plastic film 511 and an adhesive layer 520 and a fourth plastic film 532 disposed between a second plastic film 531 and the adhesive layer 520.

In addition, in the second exemplary embodiment, the sum of the thickness of the first plastic film 511 and the thickness of the third plastic film 512 is included in a range of approximately 0.25 mm to 0.35 mm, and the sum of the thickness of the second plastic film 531 and the thickness of the fourth plastic film 532 is included in a range of approximately 0.25 mm to 0.35 mm. In addition, the adhesive layer 520 has a thickness included in a range of approximately 0.05 mm to 0.15 mm.

Meanwhile, the first plastic film 511 and the second plastic film 531 may be formed of the same material, and the third plastic film 512 and the fourth plastic film 532 may be formed of the same material.

However, the second exemplary embodiment is not limited thereto. That is, the first plastic film 511 and the fourth plastic film 532 may be formed of the same material, and the second plastic film 531 and the third plastic film 512 may be formed of the same material.

With such a configuration, the display protection window 502 constructed as the second exemplary embodiment can have improved impact resistance while having a relatively slim thickness and can effectively suppress warpage thereof.

In particular, the display protection window 502 constructed as the second exemplary embodiment can further effectively suppress thermal distortion.

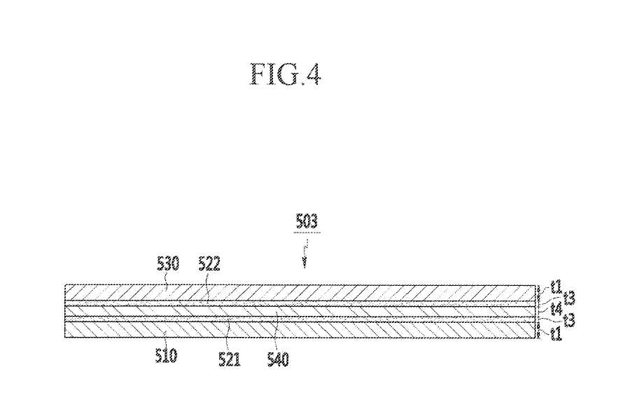

Hereinafter, a display protection window 503 constructed as a third exemplary embodiment according to the principles of the present invention will be described with reference to FIG. 4.

As shown in FIG. 4, an adhesive layer of a display protection window 503 according to the third exemplary embodiment includes a first adhesive later 521 adjacent to a first plastic film 510 and a second adhesive layer 522 adjacent to a second plastic film 530. In addition, the display protection window 503 further includes an additional plastic film 540 disposed between the first adhesive layer 521 and the second adhesive layer 522.

In the third exemplary embodiment, the first adhesive layer 521 and the second adhesive layer 522 may respectively have a thickness t3 of approximately 0.01 mm to 0.1 mm. The additional plastic film 540 may have a thickness t4 of approximately 0.15 mm to 0.3 mm.

In addition, as in the first exemplary embodiment, the first plastic film 510 and the second plastic film 530 may respectively have a thickness t1 of 0.25 mm to 0.35 mm.

With such a configuration, impact resistance of the display protection window 503 according to the third exemplary embodiment can be further improved by reinforcing a buffering function using the plurality of adhesive layers 521 and 522.

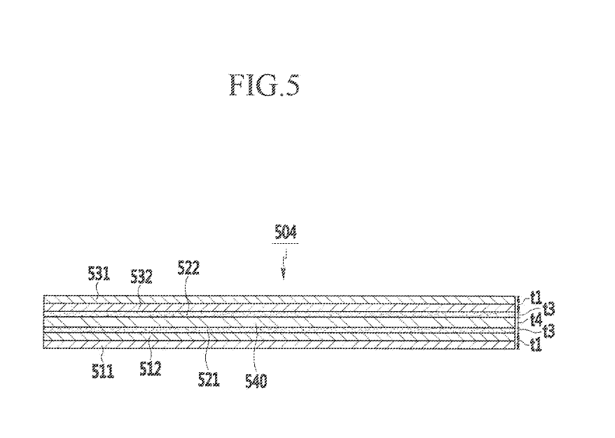

Hereinafter, a display protection window 504 constructed as a fourth exemplary embodiment according to the principles of the present invention will be described with reference to FIG. 5.

As shown in FIG. 5, an adhesive layer of the display protection window 504 according to the fourth exemplary embodiment includes a first adhesive layer 521 adjacent to a first plastic film 511 and a second adhesive layer 522 adjacent to a second plastic film 531. In addition, the display protection window 504 further includes an additional plastic film 540 disposed between the first adhesive layer 521 and the second adhesive layer 522.

Further, in the fourth exemplary embodiment, the first adhesive layer 521 and the second adhesive layer 522 may respectively have a thickness t3 of approximately 0.01 mm to 0.1 mm. In addition, the additional plastic film 540 may have a thickness t4 of approximately 0.15 mm to 0.3 mm.

In addition, the display protection window 504 further includes a third plastic film 512 disposed between the first plastic film 511 and the first adhesive layer 521 and a fourth plastic film 532 disposed between the second plastic film 531 and the second adhesive layer 522.

In the fourth exemplary embodiment, a sum t1 of the thickness of first plastic film 511 and the thickness of the third plastic film 512 is included in a range of approximately 0.25 mm to 0.35 mm, and a sum t1 of the thickness of the second plastic film 531 and the thickness of the fourth plastic film 532 is included in a range of approximately 0.25 mm to 0.35 mm.

Meanwhile, the first plastic film 511 and the second plastic film 531 may be formed of the same material, and the third plastic film 512 and the fourth plastic film 532 may be formed of the same material.

However, the fourth exemplary embodiment is not limited thereto. That is, the first plastic film 511 and the fourth plastic film 532 may be formed of the same material, and the second plastic film 531 and the third plastic film 512 may be formed of the same material.

With such a configuration, impact resistance of the display protection window 504 according to the fourth exemplary embodiment can be further improved by reinforcing a buffering function using the plurality of adhesive layers 521 and 522.

In addition, the display protection window 504 according to the fourth exemplary embodiment can further effectively suppress thermal distortion.

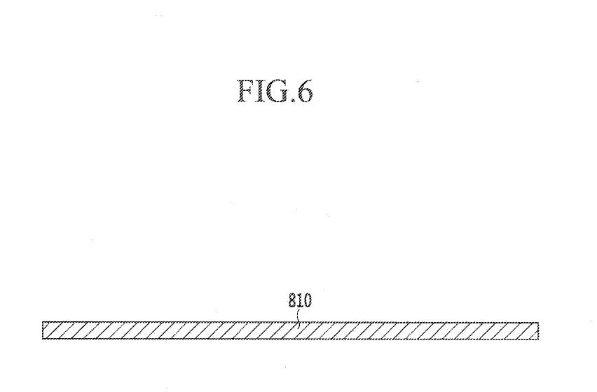

Hereinafter, experimental examples according to the first exemplary embodiment and comparative examples 1, 2, and 3 will be described with reference to FIG. 6 to FIG. 8. Here, the comparative examples 1, 2, 3 respectively have different structures.

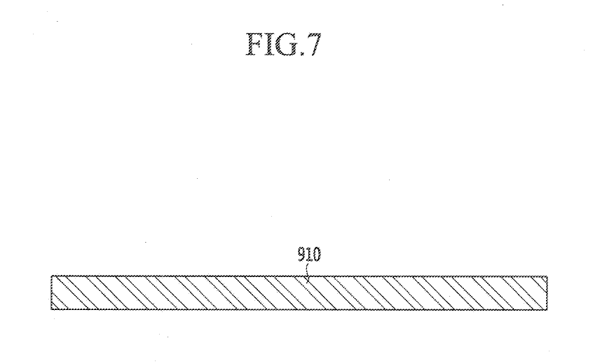

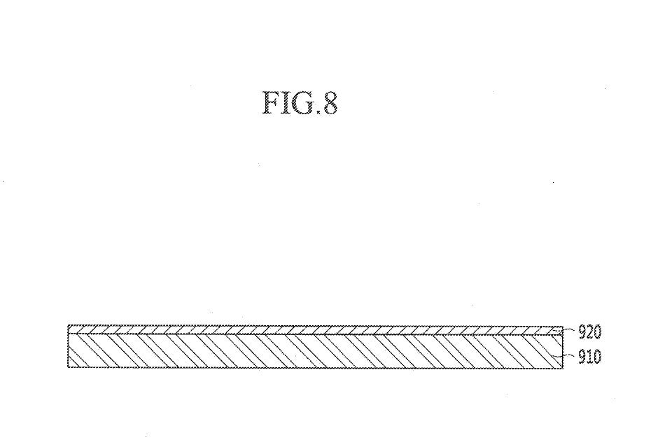

A first experiment was performed to measure an impact resistance characteristic through a drop test using an experiment example of the first exemplary embodiment, comparative example 1 having a structure of FIG. 6, comparative example 2 having a structure of FIG. 7, and comparative example 3 having a structure of FIG. 8.

In further detail, the experimental example had a multi-layered structure funned of PMMA film/OCA layer/PMMA film according to the first exemplary embodiment. In addition, the total thickness of the experimental example was 0.7 mm.

Comparative example 1 was formed of a single plate 810 formed of acryl. In the comparative example 1, the thickness was 0.3 mm.

In comparative example 2, a PMMA film 910 was formed of a single plate and the thickness thereof was 0.65 mm.

Comparative example 3 was formed of a PMMA film 910 having a thickness of 0.6 mm and a PC film 920 having a thickness of 0.05 mm, as shown in FIG. 8.

TABLE 1

| Type | Crack drop height |
|---|---|
| Experimental Example | 80 cm |
| Comparative Example 1 | 10 cm |
| Comparative Example 2 | 10 cm |
| Comparative Example 3 | 15 cm |

As shown in Table 1, damage occurred when the drop height is over 80 cm in the experimental example. On the contrary, damage occurred when the drop height is less than or equal to 15 cm in the comparative examples. It could be observed through the first experiment, the experimental example had 5 to 8 times excellent impact resistance compared to the comparative examples 1, 2, and 3.

Hereinafter, a second experiment is performed using the experimental example according to the first exemplary embodiment and comparative examples 4 and 5 respectively having different structures.

The second experiment was performed to measure an impact resistance characteristic through a drop test with an experimental example according to the first exemplary embodiment and comparative example 4 and comparative example 5 having the same structure of the experimental example and different thickness ratios.

In further detail, in the experimental example, a multi-layered structure is formed of a PMMA film/an OCA layer/a PMMA film with interlayer thickness of 0.3 mm/0.1 mm/0.3 mm.

In the comparative example 4, a multi-layered structure is formed of a PMMA film/an OCA layer/a PMMA film with interlayer thickness of 0.2 mm/0.1 mm/0.2 mm.

In the comparative example 5, a multi-layered structure is formed of a PMMA film/an OCA layer/a PMMA film with interlayer thickness of 0.5 mm/0.1 mm/0.5 mm.

TABLE 2

| Type | Total thickness | Crack drop height |
|---|---|---|
| Experimental Example | 0.7 mm | 80 cm |
| Comparative Example 4 | 0.5 mm | 20 cm |
| Comparative Example 5 | 1.1 mm | 10 cm |

As shown in Table 2, a damage was occurred when a drop height was over 80 cm in the experimental example but a damage was occurred when a drop height was less than or equal to 20 cm in the comparative examples. It could be observed through the second experiment, the experimental example had 4 to 8 times excellent impact resistance compared to the comparative examples 4 and 5.

In general, it can be expected that a specific characteristic is linearly increased or decreased as the thickness is increased or decreased, but it can be observed that the experimental example according to the first exemplary embodiment has a critical effect such that the experimental example is free from a prediction range through the second experimental example.

Through the first and second experimental examples, the display protection window according to the first exemplary embodiment has an excellent characteristic of being free from a prediction range compared to protection windows having various known structures.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: display panel | 101: display device |
| 110: display substrate | 210: encapsulation substrate |
| 250: driving circuit element | 501: display protection window |
| 510: first plastic film | 520: adhesive layer |
| 530: second plastic film | |

What is claimed is:

1. A display protection window, comprising:
a first plastic film;
a second plastic film arranged opposite to the first plastic film; and
an adhesive layer disposed between the first plastic film and the second plastic film to bond the first plastic film and the second plastic film to each other.

2. The display protection window of claim 1, wherein the adhesive layer is at least one of an optical clear adhesive (OCA) layer and a super view resin (SVR).

3. The display protection window of claim 1, wherein the first plastic film and the second plastic film respectively include at least one of polyp methacrylate (PMMA) and polysilsesquioxane.

4. The display protection window of claim 1, wherein the first plastic film and the second plastic film respectively have a thickness included in a range of approximately 0.25 mm to 0.35 mm, and the adhesive layer has a thickness included in a range of approximately 0.05 mm to 0.15 mm.

5. The display protection window of claim 1, farther comprising a third plastic film disposed between the first plastic film and the adhesive layer and a fourth plastic film disposed between the second plastic film and the adhesive layer.

6. The display protection window of claim 5, wherein the sum of the thickness of the first plastic film and the thickness of the third plastic film is included in a range of approximately 0.25 mm to 0.35 mm, the sum of the thickness of the second plastic film and the thickness of the fourth plastic film is included in a range of approximately 0.25 mm to 0.35 mm, and the adhesive layer has a thickness included in a range of approximately 0.05 mm to 0.15 mm.

7. The display protection window of claim 5, wherein the first plastic film and the second plastic film are formed of the same material, and the third plastic film and the fourth plastic film are formed of the same material.

8. The display protection window of claim 5, wherein the first plastic film and the fourth plastic film are formed of the same material, and the second plastic film and the third plastic film are formed of the same material.

9. The display protection window of claim 1, wherein the adhesive layer comprises a first adhesive layer adjacent to the first plastic film and a second adhesive layer adjacent to the second plastic film, and farther comprises an additional plastic film disposed between the first adhesive layer and the second adhesive layer.

10. The display protection window of claim 9, wherein the first adhesive layer and the second adhesive layer respectively have a thickness included in a range of approximately 0.01 mm to 0.1 mm, and the additional plastic film has a thickness included in a range of approximately 0.15 mm to 0.3 mm.

11. The display protection window of claim 10, wherein the first plastic film and the second plastic film respectively have a thickness included in a range of approximately 0.25 mm to 0.35 mm.

12. The display protection window of claim 9, further comprising a third plastic film disposed between the first plastic film and the first adhesive layer and a fourth plastic film disposed between the second plastic film and the second adhesive layer.

13. The display protection window of claim 12, wherein the sum of the thickness of the first plastic film and the thickness of the third plastic film is included in a range of approximately 0.25 mm to 0.35 mm, the sum of the thickness of the second plastic film and the thickness of the fourth plastic film is included in a range of approximately 0.25 mm to 0.35 mm, and the adhesive layer has a thickness included in a range of approximately 0.05 mm to 0.15 mm.

14. The display protection window of claim 12, wherein the first plastic film and the second plastic film are formed of the same material, and the third plastic film and the fourth plastic film are formed of the same material.

15. The display protection window of claim 12, wherein the first plastic film and the fourth plastic film are formed of the same material, and the second plastic and the third plastic film are formed of the same material.

16. A display device, comprising:
a display panel displaying an image, and
the display protection window in claim 1, disposed on the display panel to protect the display panel.

17. The display device of claim 16, wherein the display panel is one of an organic light emitting diode display panel, a liquid crystal display panel, and an electrophoretic display panel.
